(19) United States
(12) Patent Application Publication
(10) Pub. No.: US 2008/0072838 A1
(43) Pub. Date: Mar. 27, 2008

(54) Pet carrier

(76) Inventors: Shannon Beach, North Hollywood, CA (US); Aurelia Ruth Bishop, Indianapolis, IN (US)

Correspondence Address: BELASCO, JACOBS & TOWNSLEY LLP;HOWARD HUGHES CENTER, 6100 CENTER DRIVE, SUITE 630, LOS ANGELES, CA, 90045, US

(21) Appl. No.: 11/512,672

(22) Filed: Aug. 30, 2006

(51) Int. Cl. A01K 1/03

(52) U.S. Cl. 119/497

(57) ABSTRACT

A pet carrier includes a lateral support panel sized and shaped to fit beneath an abdomen of a pet. The lateral panel has a pair of foreleg openings and a pair of back leg openings sized and disposed to permit entry of the forelegs and back legs of the pet. A front support panel extends forewardly from the lateral panel adjacent the foreleg openings. A rear support panel extends rearwardly from the lateral panel adjacent the back leg openings. Side support panels are located along the sides of the lateral panel. A carrying strap is attached to the pet carrier that includes an adjustable front strap and at least one rear strap. The rear strap is attached at opposite rear corners of the carrier and loops around the front strap to provide for carrying comfort. A storage pocket is provided on the lateral panel for storage of the folded carrier.

### FIELD OF INVENTION

The invention pertains to pet transportation systems. More particularly, the invention relates to devices for carrying small pets adjacent a pet owner's body.

### BACKGROUND OF THE INVENTION

Pet owners often desire to bring their pets with them when walking, however, many smaller pets cannot walk long distances easily or may be subject to injury when walking in crowded environments such as malls or city streets. New puppies or kittens are also difficult to walk with and yet are often awkward to carry. For these reasons, various designs for pet carrier have been developed by inventors. The present invention provides a flexible, woven carrier that holds the pet securely while providing a comfortable, adjustable carrying arrangement for the pet owner.

U.S. Pat. No. 6,286,461, issued to Martz discloses a portable animal carrier is provided which is of a size to comfortably hold a small pet, such as a cat or dog, and may be placed under an airline seat. Carrier straps are included to provide a versatility of to table options, which include carrying the portable animal carrier as a backpack, shoulder bag, or hand tote. The portable animal carrier may preferably have a tapered contour to facilitate it smoothly lying against the user's body when being transported as a backpack or shoulder bag.

U.S. Pat. No. 6,595,396, issued to Cummings is directed to a child or pet carrier characterized by an over-the-shoulder sling of sufficient width and strength to support the weight of an infant, young child, or small pet which connects to an increased width of fabric or joined panels of fabric designed and constructed to form a holding portion that allows the child to rest in a sitting or reclined posture when held against the side, hip, or torso area of a carrying adult and that is further enhanced by an integrated drawstring, adjustable strap, or rubberized compression cord that runs along one transverse side of the holding portion that can be adjusted in such a manner as to create a more stable back and/or side support for the child or pet held therein.

U.S. Pat. No. 5,044,321, issued to Selph illustrates a protective pet carrier for protecting and transporting a pet during vehicular transportation. The protective pet carrier includes a web and a restraining pouch which encompasses a substantial portion of a body of the pet so that the pet is effectively rendered immobile in the pouch and no firm foundation exists as would be required for the pet to spring from the pouch for escape. The carrier is attached to an associated structure via a hood which may fit over a head rest of an automobile seat. Alternately, plural straps may be utilized for attaching pet carrier either to a person's body or automobile seats. In another embodiment, a frame is provided for securing the pet carrier.

U.S. Pat. No. 6,216,636, issued to Butchko discloses a device for assisting four-legged pets to walk during periods of convalescence from foot, leg, or hip surgery or injury. A sling portion is connected to two handle grips. The sling portion may be disposed under the chest of the animal in the case of debilitated front legs, or under the abdomen in the case of debilitated hind legs, and the handle grips grasped by a human user to help support or lift the pet. The invention is particularly useful for assisting a convalescent pet to take beneficial walks without having to bear full weight on injured limbs or hips. A version of the device is disclosed which may be adjusted in length to accommodate the size of the animal and the height of the user.

U.S. Pat. No. 6,595,162, issued to Hibbert is directed to a cover for animals. The cover comprises a main body, a strap system sewn to main body, and a fastening system arranged to join two edges of the main body. So joined, main body extends around at least a portion of the animal, portions of the animal extend through first and second open ends of the main body, and the strap system extends under the animal with handle portions of the strap system arranged above the animal. Grasping the handle portions of the strap system allows the animal to be lifted with the weight of the animal being carried at least in part by support straps of the strap system.

U.S. Pat. No. 5,894,817, issued to Manuel discloses a pet carrier that includes a garment having a pair of left and right side panels extending from a center bottom panel. Each panel has forward and rear leg openings. The opposite ends of a shoulder strap are releasably attached to linking device on the panels' edges. By unhooking the shoulder strap only from the tail side linking device, the carrier is turned into a collarless leash for the pet.

U.S. Pat. No. 4,644,902, issued to Doyle describes pet carrier comprises a sling of flexible sheet material having a body portion with holes for receiving the pet's legs and straps extending from the sides of the body portion which are drawn over the pet's body and secured together so that the carrier may be slung over a user's shoulder or arm or carried in the hand. The carrier provides comfortable and secure support for the pet. A pair of restraining straps is secured to the body portion outwardly of the leg receiving holes with “Velcro” fastening tapes adjustably connecting the restraining straps for snug engagement over the back of a pet to prevent the pet from retracting its legs from the holes thereby securely retaining the pet in the carrier.

U.S. Pat. No. 6,802,282, issued to Muckleroy discloses a new and improved multi-function pet carrier comprising a flexible panel overlapped perpendicularly by a flexible panel. One of the flexible panels can be formed into pockets for carrying needed articles. The other flexible panel can be cushioned. Corners of the panels are connected with adjustable straps. Strap combinations are fixed to what are normally corners of the panels to form said pet carrier for wearing in a horizontal position on a bearer's body adjacent to an abdomen, a back, over a shoulder, over a shoulder across bearer's torso to hip and by a hand. Rings threaded over straps provide tightening of panels to the pet's body. Securing straps over a car seat parallel and flush to car seat's back provide secure travel for a pet. A hook and loop type fastener on the pocketed panel provide additional restraint to the pet from shifting in the pet carrier.

U.S. Patent Application No. 2005/0263102, issued to Sherman describes a wearable, multi-positional apparatus and method for transporting an animal horizontally in an adjustable, body-conforming apparatus worn about the human torso. The carrier consists of a convex shaped main body panel bound at it perimeter by flexible, semi-rigid binding material. The body panel passes beneath and is drawn up around the animal that is secured under its hindquarters and beneath the chest area in front of the forelegs away from the esophageal area with the pet in a natural horizontal level orientation. The carrier provides for leg openings that are cushioned and mold around the animal's legs to produce a custom fit. The animal within the apparatus can be carried by hand via tote style handles, and has a multi-positional strap system that permits the carrier to be draped over the shoulder, around a person's waist, across the human chest, or converted to a leash.

It is an objective of the present invention to provide a comfortable means to carry a small pet about the body of a pet owner. It is a further objective to provide a pet carrier with an open top that is cool and comfortable for the pet while insuring that the animal cannot easily escape from the carrier. It is a still further objective of the invention to provide a carrier that can be adjusted for a number of comfortable carrying positions. It is yet a further objective to provide a carrier that is adaptable to several sizes of pets. Finally, it is an objective of the present invention to provide a carrier that folds compactly when not in use and stores easily in an attached pocket.

While some of the objectives of the present invention are disclosed in the prior art, none of the inventions found include all of the requirements identified.

### SUMMARY OF THE INVENTION

The present invention addresses all of the deficiencies of prior pet carrier inventions and satisfies all of the objectives described above.

(1) A pet carrier providing the desired features may be constructed from the following components. A lateral support panel is provided. The lateral support panel is sized and shaped to fit beneath an abdomen of a pet. The lateral support panel has a pair of foreleg openings and a pair of back leg openings. The openings are sized and located to permit entry of the forelegs and back legs of the pet. A front support panel is provided. The front support panel extends forewardly from the lateral support panel adjacent the foreleg openings. A rear support panel is provided. The rear support panel extends rearwardly from the lateral support panel adjacent the back leg openings. A first side support panel is provided. The first side support panel extends outwardly from a first side of the lateral support panel adjacent one of the foreleg openings and one of the back leg openings. A second side support panel is provided. The second side support panel is located opposite the first side support panel and extends outwardly from an opposite second side of the lateral support panel adjacent an opposite foreleg opening and an opposite back leg opening. At least one carrying strap is provided. The carrying strap is attached to the pet carrier. When the pet is supported by the lateral support panel with its forelegs located through the foreleg openings and its back legs located through the back leg openings and when the carrying strap is located over either a neck or shoulder of a pet owner, the pet will be secured within the pet carrier for transport by the pet owner.

(2) In a variant of the invention, the front support panel is attached to the first side support panel and the second side support panel.

(3) In another variant, the rear support panel is attached to the first side support panel and the second side support panel.

(4) In still another variant, the at least one carrying strap further includes a front strap. The front strap is attached at a first end adjacent a juncture of the front support panel and the first side support panel and attached at a second end adjacent a juncture of the front support panel and the second side support panel.

(5) In yet another variant, the front strap is adjustable in length.

(6) In a further variant, the front strap further includes a padded section.

(7) In still a further variant, the at least one carrying strap further includes at least one rear strap. The rear strap is attached at a first end adjacent a juncture of the rear support panel and the first side support panel and attached at a second end adjacent a juncture of the rear support panel and the second side support panel.

(8) In another variant of the invention, the rear strap is looped about the front strap.

(9) In yet another variant, a first portion of the rear strap is fastened to a second portion of the rear strap, thereby forming a closed loop about the front strap.

(10) In still another variant, the at least one rear strap includes a first side rear strap and a second side rear strap.

(11) In a further variant, the first side rear strap is attached at a first end adjacent a juncture of the rear support panel and the first side support panel and looped about the front strap adjacent a second end. The second side rear strap is attached at a first end adjacent a juncture of the rear support panel and the second side support panel and looped about the front strap adjacent a second end. The second ends of the first and second side rear straps are fastened to points spaced from the second ends of the first and second side rear straps, thereby forming a pair of closed loops about the front strap.

(12) In still a further variant, a strengthening ridge is provided. The ridge is located adjacent at least a portion of an outer perimeter of the lateral support panel.

(13) In a final variant, a storage pocket is provided. The storage pocket is located on the lateral support panel and is sized and shaped to store the pet carrier inside it.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 is a perspective view of the preferred embodiment of the invention illustrating the carrier disposed on the shoulder of a pet owner;

FIG. 2 is a perspective view of the FIG. 1 embodiment illustrating the carrying strap arrangement;

FIG. 2A is a perspective view of an alternative embodiment of the invention illustrating a dual rear strap arrangement; and

FIG. 3 is a perspective view of the underside of the FIG. 1 embodiment illustrating the foreleg and back leg openings.

### DETAILED DESCRIPTION OF THE PREFERRED EMBODIMENT

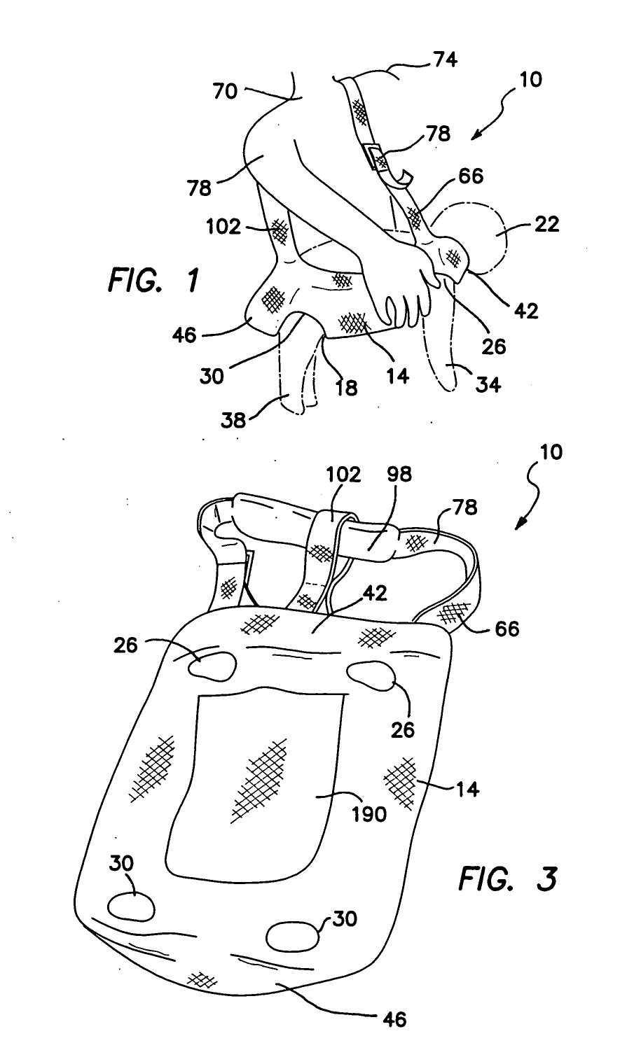

(1) FIGS. 1-3 illustrate pet carrier 10 providing the desired features that may be constructed from the following components. A lateral support panel 14 is provided. The lateral support panel 14 is sized and shaped to fit beneath an abdomen 18 of a pet 22. The lateral support panel 14 has a pair of foreleg openings 26 and a pair of back leg openings 30. The openings 26, 30 are sized and located to permit entry of the forelegs 34 and back legs 38 of the pet 22. A front support panel 42 is provided. The front support panel 42 extends forewardly from the lateral support panel 14 adjacent the foreleg openings 26. A rear support panel 46 is provided. The rear support panel 46 extends rearwardly from the lateral support panel 14 adjacent the back leg openings 30. A first side support panel 50 is provided.

The first side support panel 50 extends outwardly from a first side 54 of the lateral support panel 14 adjacent one of the foreleg openings 26 and one of the back leg openings 30. A second side support panel 58 is provided. The second side support panel 58 is located opposite the first side support panel 50 and extends outwardly from an opposite second side 62 of the lateral support panel 14 adjacent an opposite foreleg opening 26 and an opposite back leg opening 30. At least one carrying strap 66 is provided. The carrying strap 66 is attached to the pet carrier 10. When the pet 22 is supported by the lateral support panel 14 with its forelegs 34 located through the foreleg openings 26 and its back legs 38 located through the back leg openings 30 and when the carrying strap 66 is located over either a neck 70 or shoulder 74 of a pet owner 78, the pet 22 will be secured within the pet carrier 10 for transport by the pet owner 78.

(2) In a variant of the invention, the front support panel 42 is attached to the first side support panel 50 and the second side support panel 58.

(3) In another variant, the rear support panel 46 is attached to the first side support panel 50 and the second side support panel 58.

(4) In still another variant, the at least one carrying strap 66 further includes a front strap 78. The front strap 78 is attached at a first end 82 adjacent a juncture 86 of the front support panel 42 and the first side support panel 50 and attached at a second end 90 adjacent a juncture 94 of the front support panel 42 and the second side support panel 58.

(5) In yet another variant, the front strap 78 is adjustable in length.

(6) In a further variant, the front strap 78 further includes a padded section 98.

(7) In still a further variant, the at least one carrying strap 66 further includes at least one rear strap 102. The rear strap 102 is attached at a first end 106 adjacent a juncture 110 of the rear support panel 46 and the first side support panel 50 and attached at a second end 114 adjacent a juncture 118 of the rear support panel 46 and the second side support panel 58.

(8) In another variant of the invention, the rear strap 102 is looped about the front strap 78.

(9) In yet another variant, a first portion 122 of the rear strap 102 is fastened to a second portion 126 of the rear strap 102, thereby forming a closed loop 130 about the front strap 78.

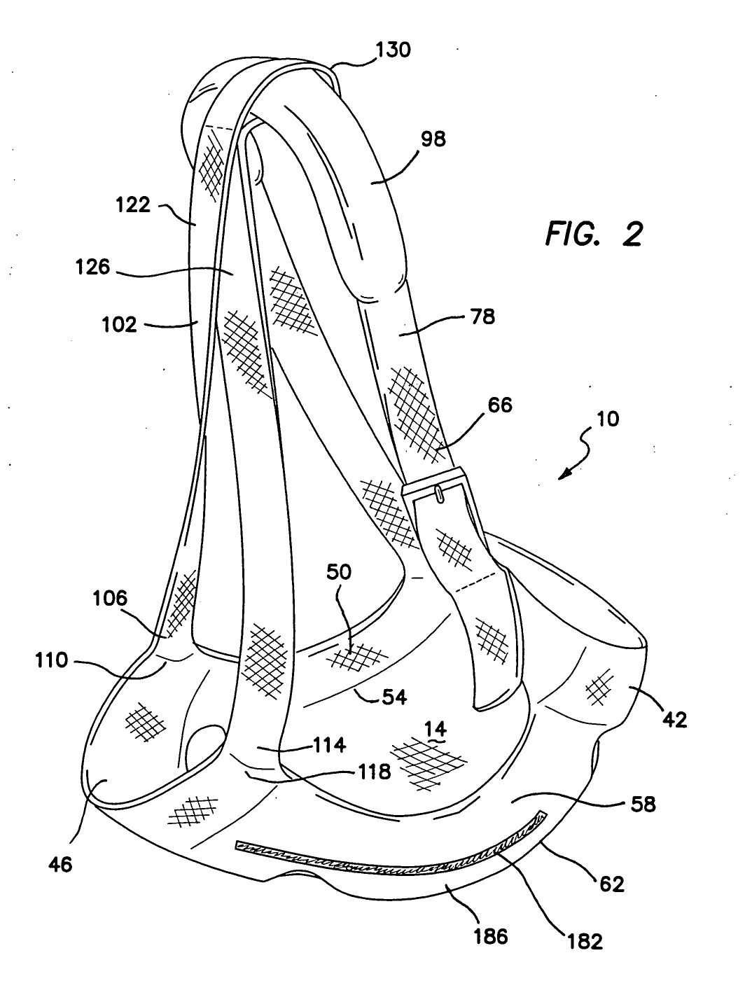

(10) In still another variant, as illustrated in FIG. 2A, the at least one rear strap 102 includes a first side rear strap 134 and a second side rear strap 138.

(11) In a further variant, the first side rear strap 134 is attached at a first end 142 adjacent a juncture 110 of the rear support panel 46 and the first side support panel 50 and looped about the front strap 78 adjacent a second end 150. The second side rear strap 138 is attached at a first end 154 adjacent a juncture 118 of the rear support panel 46 and the second side support panel 58 and looped about the front strap 78 adjacent a second end 162. The second ends 150, 162 of the first 134 and second 138 side rear straps are fastened to points 166, 170 spaced from the second ends 150, 162 of the first 134 and second 138 side rear straps, thereby forming a pair of closed loops 174, 178 about the front strap 78.

(12) In still a further variant, as illustrated in FIGS. 2 and 2A, a strengthening ridge 182 is provided. The ridge 182 is located adjacent at least a portion of an outer perimeter 186 of the lateral support panel 14.

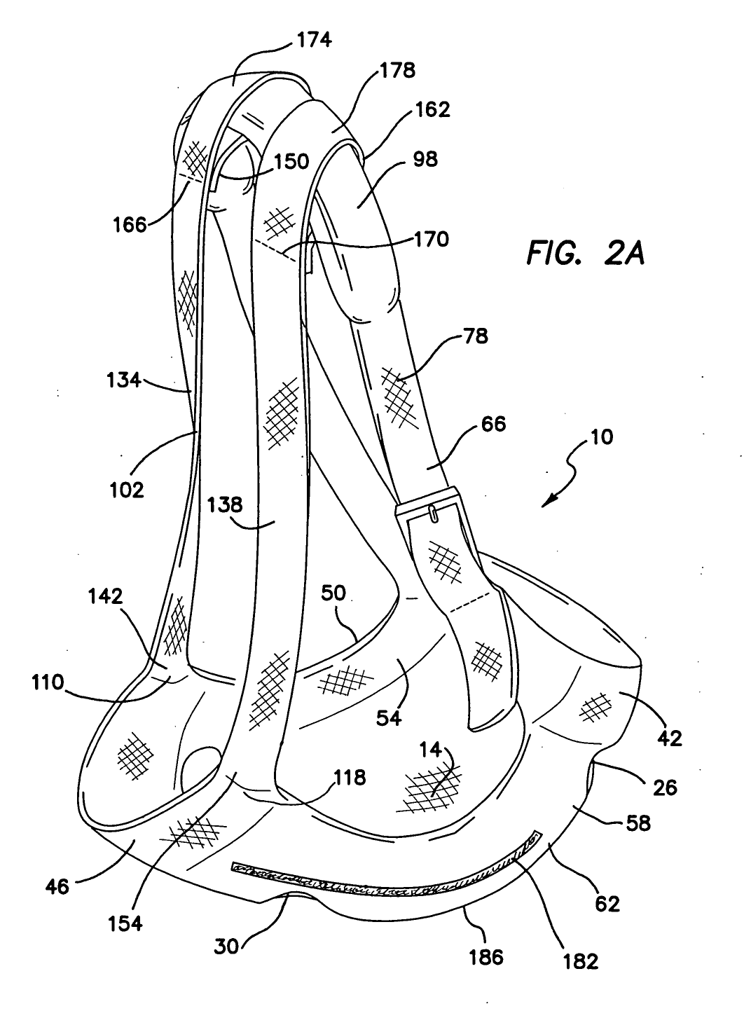

(13) In a final variant, as illustrated in FIG. 3, a storage pocket 190 is provided. The storage pocket 190 is located on the lateral support panel 14 and is sized and shaped to store the pet carrier 10 inside it.

The pet carrier 10 has been described with reference to particular embodiments. Other modifications and enhancements can be made without departing from the spirit and scope of the claims that follow.

1. A pet carrier, comprising:
a lateral support panel, said lateral support panel being sized and shaped to fit beneath an abdomen of a pet;
said lateral support panel having a pair of foreleg openings and a pair of back leg openings, said openings being sized and disposed to permit entry of the forelegs and back legs of said pet;
a front support panel, said front support panel extending forewardly from said lateral support panel adjacent said foreleg openings;
a rear support panel, said rear support panel extending rearwardly from said lateral support panel adjacent said back leg openings;
a first side support panel, said first side support panel extending outwardly from a first side of said lateral support panel adjacent one of said foreleg openings and one of said back leg openings;
a second side support panel, said second side support panel disposed opposite said first side support panel and extending outwardly from an opposite second side of said lateral support panel adjacent an opposite foreleg opening and an opposite back leg opening;
at least one carrying strap, said carrying strap being attached to said pet carrier; and
whereby, when said pet is supported by said lateral support panel with its forelegs disposed through said foreleg openings and its back legs disposed through said back leg openings and when said carrying strap is disposed over either of a neck and shoulder of a pet owner, said pet will be secured within said pet carrier for transport by said pet owner.

2. The pet carrier, as described in claim 1, wherein said front support panel is attached to said first side support panel and said second side support panel.

3. The pet carrier, as described in claim 1, wherein said rear support panel is attached to said first side support panel and said second side support panel.

4. The pet carrier, as described in claim 1, wherein said at least one carrying strap further comprises a front strap, said front strap being attached at a first end adjacent a juncture of said front support panel and said first side support panel and attached at a second end adjacent a juncture of said front support panel and said second side support panel.

5. The pet carrier, as described in claim 4, wherein said front strap is adjustable in length.

6. The pet carrier, as described in claim 4, wherein said front strap further comprises a padded section.

7. The pet carrier, as described in claim 1, wherein said at least one carrying strap further comprises at least one rear strap, said rear strap being attached at a first end adjacent a juncture of said rear support panel and said first side support panel and attached at a second end adjacent a juncture of said rear support panel and said second side support panel.

8. The pet carrier, as described in claim 7, wherein said rear strap is looped about said front strap.

9. The pet carrier, as described in claim 8, wherein a first portion of said rear strap is fastened to a second portion of said rear strap, thereby forming a closed loop about said front strap.

10. The pet carrier, as described in claim 7, wherein said at least one rear strap comprises a first side rear strap and a second side rear strap.

11. The pet carrier, as described in claim 10, wherein:
said first side rear strap is attached at a first end adjacent a juncture of said rear support panel and said first side support panel and looped about said front strap adjacent a second end;
said second side rear strap is attached at a first end adjacent a juncture of said rear support panel and said second side support panel and looped about said front strap adjacent a second end;
said second ends of said first and second side rear straps being fastened to points spaced from said second ends of said first and second side rear straps, thereby forming a pair of closed loops about said front strap.

12. The pet carrier, as described in claim 1, further comprising a strengthening ridge, said ridge disposed adjacent at least a portion of an outer perimeter of said lateral support panel.

13. The pet carrier, as described in claim 1, further comprising a storage pocket, said storage pocket being disposed upon said lateral support panel and being sized and shaped to store said pet carrier there within.
